(19) United States
(12) Patent Application Publication
(10) Pub. No.: US 2023/0180902 A1
(43) Pub. Date: Jun. 15, 2023

(54) Indigolite

(71) Applicants: Alice Jean Cabral, Boulder Creek, CA (US); David Elliott Cabral, Boulder Creek, CA (US)

(72) Inventors: Alice Jean Cabral, Boulder Creek, CA (US); David Elliott Cabral, Boulder Creek, CA (US)

(21) Appl. No.: 17/300,886

(22) Filed: Dec. 9, 2021

(51) Int. Cl. A45C 15/06; F21V 33/00; F21V 21/08; G06F 3/16

(52) U.S. Cl. CPC A45C 15/06; F21V 33/0004; F21V 21/0832; G06F 3/167; F21Y 2115/10

(57) ABSTRACT

First part.
a.) Purse(s), backpack(s) and luggage are in-lined with LEDs that help to illuminate areas that are dark and difficult to retrieve items that are easier to locate,
b.) Illumination swap allows for solid or multiple color LEDs to enjoy any festivity, blinking, dimmers and sequenced can be managed.

Second part.
a.) A rectangular electronic device (human interface device) helps to keep track and store previous usages as to remind user/owner of itemized items are or not inside purse, backpack, luggage. Recalls and reminds individuals of items programed.
b.) Later voice and vibration will be added to device as easier means of communication between device and human(s)

The provisional patent application date and number is Dec. 14, 2020, U.S 63/205,459.

### BACKGROUND OF INDIGOLITE

There are two parts to this innovation divided up into (a) being the illuminating part, and (b) which is the human interface device. Each design section has both parts.

(a) (several light sources inside all types of baggage's, (b) creation of itemized listing of belongings, tracking, storing & recalling lists, manual input later voice input can be added.)

### CONCISE SUMMARY OF INDIGOLITE

precisely placed LEDs with an interchangeable battery replacement pack(s) small and neatly concealed withing the layers of fabric within a bag, (type.) this innovation allows for individuals to find an item(s) with aid of a light source inside bag, backpack, purse, baggage, etc)

A small rectangular flat screen which is connected to the same power source as the LEDs, this flat screen is woven within the fabric's outer layer of the purse, backpack, etc. as for easy accessibility. This human interface allows the user to adequately list all items placed inside or out of the bag(type) this device allows the user to keep track of stored items and recall list of data, pre-stored list to be used at later times with option to modify list, notice items that are not in bag, aids the user of itemized list, helps to track over long travel as in airports, trains, buses, at a later time this device will Bluetooth to cell phone, personalize to notify(by voice) when object is not in bag(type).

### BRIEF DESCRIPTION OF DRAWING

Within each of the design types listed as (Design 1, Design 2, Design 3, and Design 4 have design characteristics that are similar to its position and construction within each design type as referring to LEDs/and power supplies within the outer and inner layer of fabric so to keep the batteries, wires and connectors from accidental exposure or handling, this is also to aid in easy access and replace of parts and consistency over design replication of any bag, luggage types

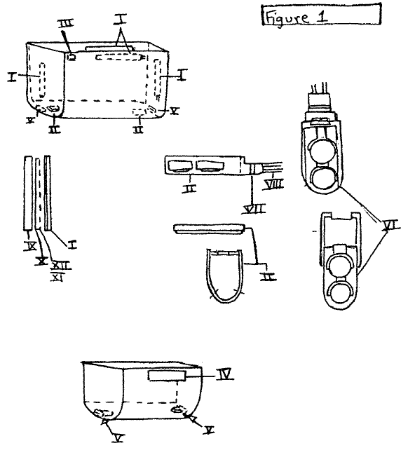

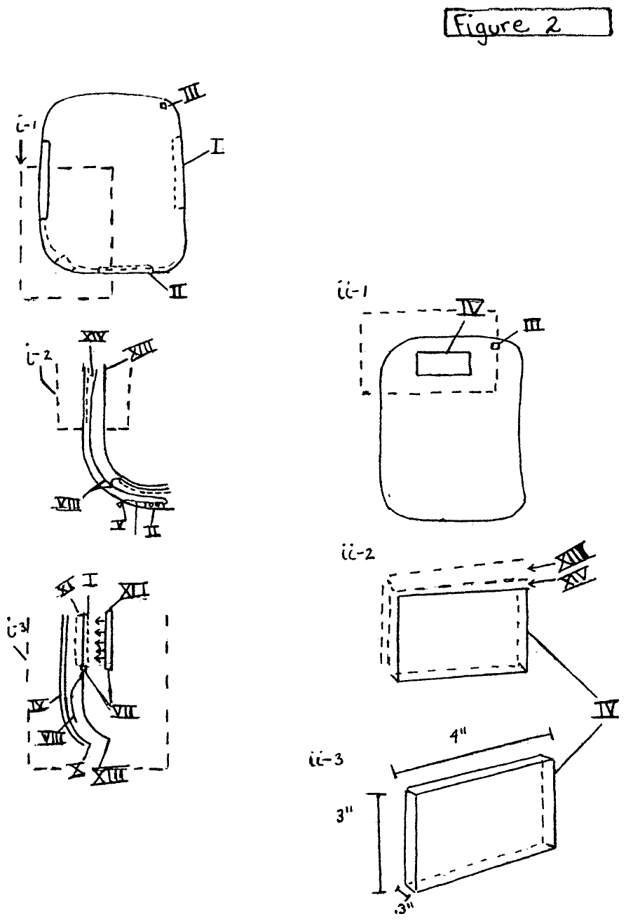

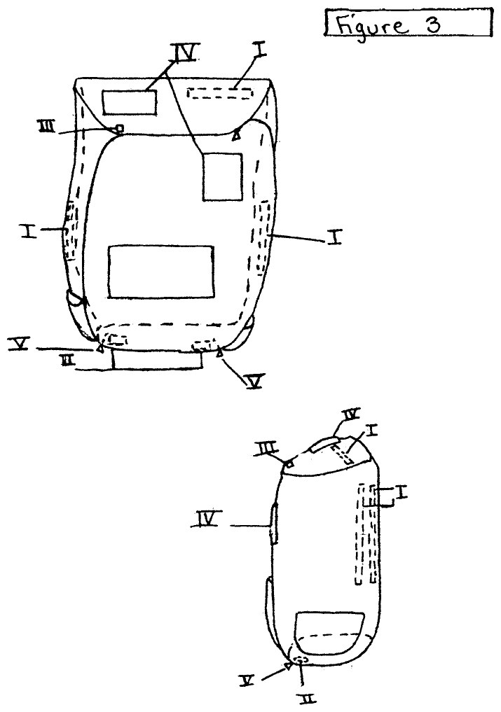

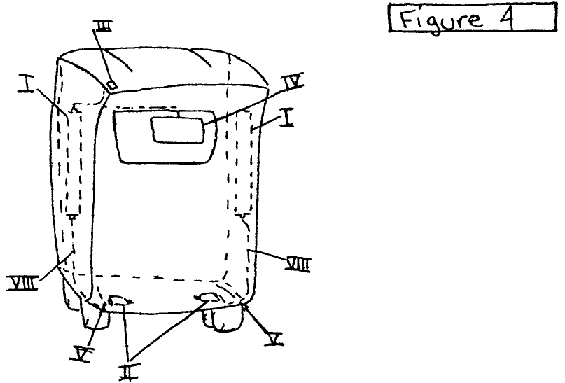

Design 1, 2, 3 and 4 have similar positions and parts listed in FIGS. 1,2,3,4.
1.0 First section of view
   near the opening close to strap is a carefully hidden Button sensor that once touched it will turn on/off the inner lighting of purse, displayed on either side of purse is the LED strips Velcro and connected to power source, this allows for easy switching of LEDs and battery packs once completely used. The battery pack and wires are neatly within between the fabric of the purse, only access by immediate location of plug connector.
   see FIG. 1.
      Design 1(a)
         IX. Outer layer material of purse. X. Inner fabric attached to outer layer material.
         XI. sown fabric of Velcro into inner fabric layer. XII. LEDs attach/detach flexible
         I. Velcro/LEDs positions within purse. II. Battery pack(s)/positions.
1.1 Second section of view.
   Purse has a flat screen display located on front side of purse, the touch screen allows for logging items and tracking of such items, notification will be applied by means of cell phone text/audible, notifying the user of missing items, save/recall itemized lists can be created, and notifications can be set accordingly to items on list. Wires to a snap connection to supply power to necessary parts that utilize power. Interchangeable part to for ease of connection/disconnection. On/off button is a simple switch component that is controlled by touch button/touch sensor, Design 2, 3 and 4 have similar positions and parts listed in FIG. 1,2,3,4.
      Design 1(b)
         III. On/off button(s) interconnected throughout by a simple wiring system & battery trays IV. a small rectangular screen (human interface device) is a simplified hardware/software to a small tablet like device connected to a station port/charging port similar to charging wire to common electrical devices. V. zipper/access point(s) VI. Retractable battery pack(s) Connector VIII. wiring
2.0 First section of view
   Within the layer of several fabrics the inner fabric for cosmetic reasons of holding and spacing the wiring throughout the Purse, bag, backpack, luggage and hiking bag, that connect to a power supply that consists of two trays on each end that securely holds two Li small flat batteries each. Placed on both sides within the layer of fabric within the Purse is stitched in hard Velcro strips one side of the end has so connects the soft side of Velcro attached to LED strip(s) placed near the edge of access point open/closed by means of zipper, these allows for easy access to change out batteries when needed. Within the same wire diagram is connected with an on/off button, All that was previously mentioned in the first and second section can be extended to backpacks, luggage camping/hiking gear (bags) see FIG. 2.
      Design 2(a)
         i-1. first sectional view displayed in depicting location of cut-out that opens to the next view.
         i-2. Second sectional view depicting the separate fabric layers and position of sed components. XIV stitching of fabric layer. XIII. The material connecting the surface fabric layer to fabric attached to small screen for added stability and firmness. V. Zipper/access point(s). II. Battery pack(s)/positions.
         i-3. Closer view of components, the fabric layers and position and direction of LED strip fits in place. XI. Sown fabric of Velcro into inner fabric layer.
         VIII. wiring. X. inner fabric attached to outer layer material. XIII. The material connecting the surface fabric layer to fabric attached to small screen for added stability and firmness. IX. Outer layer of material of Purse, backpack, luggage, etc.
         I. Velcro/LEDs positioned within backpack. II. Battery pack(s)/there positions. III. on/off button to control lights and screen.
2.1 second section of view.
   the outer layer of the fabric of the backpack, a second and third inner layers next is the surface layer inside the backpack, in the second and third layer of fabric are a set of wires that run through this layer of this backpack, as the wires link to a power source, an on/off button also to its intended LEDs and later screen display.
      Design 2(b)
         ii-1.
         IV. a small rectangular screen (human interface device) is a simplified hardware/software to a small tablet like device connected to a station port/charging port similar to charging wire to common electrical devices. III. On/off button(s) interconnected throughout by a simple wiring system & battery trays.
         ii-2.
         XIII. The material connecting the surface fabric layer to fabric attached to small screen for added stability and firmness. XIV. Stitching of fabric layer
         ii-3.
         IV. a small rectangular screen (human interface device) is a simplified hardware/software to a small tablet like device connected to a station port/charging port similar to charging wire to common electrical devices.
3.0 first section of view.
   Hiking pack has a flat screen display located on top side of Hiking pack, the touch screen allows for logging items and tracking of such items, notification will be applied by means of cell phone text/audible, notifying the user of missing items, save/recall itemized lists can be created, and notifications can be set accordingly to items on list. Wires to a snap connection to supply power to necessary parts that utilize power. Interchangeable part to for ease of connection/disconnection. On/off button is a simple switch component that is controlled by touch button/touch sensor, see FIG. 3.
      Design 3(a)
         I. Velcro/LEDs positioned within backpack. II. Battery pack(s)/there positions.
         III. on/off button to control lights and screen. V. zipper/access point(s)
3.1 second section of view.
   side and back view(s) of LEDs positions, the position of the on/off button, the power supply and flat screen device, the inline wiring at side view.
      Design 3(b)
         I. Velcro/LEDs positioned within backpack. II. Battery pack(s)/there positions.
         III. on/off button to control lights, and screen IV. a small rectangular screen (human interface device.) V. zipper/access point(s)
4.0 first section of view.
   Hiking pack has a flat screen display located on top side of Hiking pack, the touch screen allows for logging items and tracking of such items, notification will be applied by means of cell phone text/audible, notifying the user of missing items, save/recall itemized lists can be created, and notifications can be set accordingly to items on list. Wires to a snap connection to supply power to necessary parts that utilize power. Interchangeable part to for ease of connection/disconnection. On/off button is a simple switch component that is controlled by touch button/touch sensor, see FIG. 4.
      Design 4(a)
         I. Velcro/LEDs positioned within backpack. II. Battery pack(s)/there positions.
         III. on/off button to control lights, and screen IV. a small rectangular screen (human interface
         device) V. zipper/access point(s) VIII. Wiring.

### DETAILED DESCRIPTION OF INDIGOLITE

All bags, purses, backpacks, and luggage will have LED light strips to illuminate inside a purse, bag, backpack, and luggage when proper lighting is not adequate or possible to locate an item quickly without struggle.

The bag(type) is interactive with its user unlike all bag(types) in history, it has a light source to allow user(s) to locate item with adequate lighting, no other bag(type) has ever been within history.

The small screen interface allows to itemize and personalize all items inside purse, bag, backpack, or suitcase that will link to cell phone application to list each item automatically or manually into application as to keep a digital list of items to save to recall for later time also to track while during travel, personal, business via domestic or foreign trips. This is to help with packing or unpacking to keep track of items, to help recall items before all departures, also use list to recall items taken to a location this devise stores past lists for later if one needs or wants to bring same items again, has reminders to pack send to cell phone. Track items if missing during transport, it will display missing item.

To aid in everyday life, this is a necessity to help make daily life easier as it becomes a more complex world.

This is a commodity for commercial and private market, has military application, this can be marketed to business that fashion purses, bags, luggage, backpacks, etc.

### Design 1 Purse/Bag

a. The sectional hard Velcro that is sewed within the fabric at specific sites, the LEDs with soft Velcro attached (sewing) to backside of LED strips positioned to the hard Velcro within designated areas, with connector clips to power supply cords connected to the LI power supply strip, the cords, and power supply are safely hidden within between the layers of purse/bag, with a small opening on bottom with hidden zipper as to replace battery packs when necessary.
b. a small flatscreen human interface, help keep track of inventory inside purse/bag, specification is controlled by user, manually input all items in or out of purse/bag, save specific items on list to recall for a later time.

### Design 2 Backpacks

a. The sectional hard Velcro that is sewed within the fabric at specific sites, the LEDs with soft Velcro attached (sewing) to backside of LED strips positioned to the hard Velcro within designated areas, with connector clips to power supply cords connected to the LI power supply strip, the cords, and power supply are safely hidden within between the layers of Backpack/pack, with a small opening on bottom with hidden zipper as to replace battery packs when necessary.
b. a small flatscreen human interface, help keep track of inventory inside Backpack/pack, specification is controlled by user, manually input all items in or out of Backpack/pack, save specific items on list to recall for a later time

### Design 3 Hiking Bag/Lunch Case.

a. The sectional hard Velcro that is sewed within the fabric at specific sites, the LEDs with soft Velcro attached (sewing) to backside of LED strips positioned to the hard Velcro within designated areas, with connector clips to power supply cords connected to the LI power supply strip, the cords, and power supply are safely hidden within between the layers of Hiking bag/Lunch case, with a small opening on bottom with hidden zipper as to replace battery packs when necessary.
b. a small flatscreen human interface, help keep track of inventory inside Hiking bag/Lunch case, specification is controlled by user, manually input all items in or out of Hiking bag/Lunch case, save specific items on list to recall for a later time.

### Design 4 Luggage.

a. The sectional hard Velcro that is sewed within the fabric at specific sites, the LEDs with soft Velcro attached (sewing) to backside of LED strips positioned to the hard Velcro within designated areas, with connector clips to power supply cords connected to the LI power supply strip, the cords, and power supply are safely hidden within between the layers of Luggage, with a small opening on bottom with hidden zipper as to replace battery packs when necessary.
b. a small flatscreen human interface, help keep track of inventory inside Luggage, specification is controlled by user, manually input all items in or out of Luggage, save specific items on list to recall for a later time.

1. a.) The LEDs within the purse, backpack, luggage will illuminate areas which are dark and obscured to normal vision, this will aid in locating what desired object(s), the soft Velcro side will allow for easy removal and reattachment of other LEDs that have soft white light or varies color lights or flashing lights (festive) for holidays, sporting events etc. the small LI batteries will allow for prolonged usage of such LEDs with the easy port access mechanism allows user to easily change batteries when needed.
b.) The next part to the purse, backpack, and luggage will have a digital interface to record and store and track to one's phone, items carried with purse, backpack, and luggage to know what the user has and to keep track of sed items. This application can be used for everyday tracking items of personal use or business, personal vacation, travel luggage or business trips, military, and government applications.
c.) Later voice commands and scanner built-in, to move item automatically scanned into itemized inventory and updated to user/owner cell phone or manually entered in or by voice command. If sed item are not within purse, backpack, and luggage the human interface will notify owner/user by means of vibration or voice response.
